(19) United States
(12) Patent Application Publication
(10) Pub. No.: US 2009/0078163 A1
(43) Pub. Date: Mar. 26, 2009

(54) Compression Strength Cement

(75) Inventors: Michele Rossi, Peschiera Borromeo (Milano) (IT); Mario Pagliaro, Palermo (IT); Rosaria Ciriminna, Palermo (IT); Cristina Della Pina, Massa (IT); Wladimir Kesber, Holland (NL)

Correspondence Address: SHOEMAKER AND MATTARE, LTD, 10 POST OFFICE ROAD - SUITE 100, SILVER SPRING, MD, 20910, US

(73) Assignee: UNIVERSITA' DEGLI STUDI DI MILANO, Milano (IT)

(21) Appl. No.: 11/719,252

(22) PCT Filed: Nov. 11, 2005
(86) PCT No.: PCT/IT05/00657

§ 371 Date: Aug. 21, 2007

(30) Foreign Application Priority Data
Nov. 12, 2004 (IT) MI2004A002172

(51) Int. Cl. C04B 16/00

(52) U.S. Cl. 106/802

(57) ABSTRACT

The present invention relates to the use of raw glycerine as a cement additive in order to improve the compression strength thereof.

### FIELD OF THE INVENTION

The present invention relates to the use of glycerine as a cement additive in order to improve the compression strength thereof.

### BACKGROUND ART

The compression strength is the capability of a cement manufactured article to bear pressures. When the compression ultimate strength is obtained, some fractures which may cause the break of the manufactured article are generated on the surface.

Since a good compression strength is very important, different nature additives are usually added to the cement, in order to increase this parameter. These additives are usually added during the cement production, preferably during the clinker milling step.

The pure glycerine, at the experimental level, has given some good results in terms of improvement in the compression strength, but the industrial use thereof has always been limited due to the high production cost thereof. It has been surprisingly found that raw glycerine, being employed as a cement additive, provides better results than pure glycerine in terms of an increase in the compression strength.

### SUMMARY OF THE INVENTION

Therefore, the present invention relates to the use of raw glycerine for improving the cement compression strength.

### DETAILED DESCRIPTION OF THE INVENTION

By “raw glycerine” is meant glycerine having 1 to 10% by weight, preferably 4 to 6% by weight, of alkali metal inorganic salt impurities, such as sodium chloride, sodium sulphide, potassium chloride, potassium sulphate or mixtures thereof. Preferably, said impurities are sodium chloride and sodium sulphate or mixtures thereof, more preferably sodium chloride.

The raw glycerine used in this invention may be obtained by any production process, but it is preferably obtained as a by-product of the production process of biodiesel®. The latter is the trademark of an ecological fuel produced from natural resources and used either alone or in combination with diesel fuel derived from petroleum, in the compression-ignition engines (diesel engines).

From the chemical point of view, Biodiesel is a mixture of alkyl-esters produced by means of the transesterification of vegetable oils, such as soybean oil, rape oil, corn oil etc.; preferably rape oil, by using either an acid or basic catalyst.

Most of the alkyl-esters are currently produced by a basic-catalysis transesterification; for example: a vegetable oil is caused to react with an alkyl alcohol, preferably methyl alcohol, in the presence of a basic catalyst, for example either sodium or potassium hydroxide, preferably sodium hydroxide, providing a mixture of alkyl-esters, glycerine and base.

The obtained mixture is then neutralized with a mineral acid, for example hydrochloric acid, sulphuric acid etc., preferably hydrochloric acid, and the alkyl-esters (biodiesel) are separated from the remainder of the mixture. The impure glycerine obtained as a secondary product is then added to the cement without further purification.

The raw glycerine, being preferably obtained by the process described above, is incorporated into the cement during the production process thereof.

It can be added either to the clinker during the conveyance thereof to the mill for the milling process, on the conveyor belt, or directly in the mill. Preferably, the raw glycerine is added during the clinker milling step.

The raw glycerine is preferably added as an aqueous solution. The concentration of this solution usually ranges between 10% and 90% by weight, preferably 10% to 60% by weight.

The amount of glycerine aqueous solution added to the clinker ranges between 20 and 1500 ppm, (with reference to the clinker weight), preferably between 50 and 1000 ppm.

Any type of cement can be treated with the raw glycerine according to the present invention.

### Experimental Data

According to the European standard EN 196/1, plastic mortar specimens have been prepared with a cement being traditionally called “Belgium” containing 400 ppm of an aqueous solution at 50% of pure glycerine and 400 ppm of an aqueous solution at 50% of raw glycerine, respectively. Plastic mortars prepared with the same cement, this time not containing additives, have been used as a reference (“white”).

The compression strength has been measured, according to the method as set forth in the European standard EN 196/1, after 1, 2, 7 and 28 days from the packaging of the specimens. This experiment has been repeated twice by using different provenance cement, being traditionally called “Greece” and “Italy”, respectively.

In table 1 the averages of the results obtained by the described above experiments have been illustrated.

TABLE 1

| | | | | | | | | | | | Setup time | |
|---|---|---|---|---|---|---|---|---|---|---|---|---|
| | | | | | | | Compression | | | | (hours and | |
| Cement | | Blaine | PSD Laser | | | | (MPa) | | | | minutes) | |
| Additive | ppm | (cm²/g) | R32 % | R45 % | R63 % | R90 % | 1 d | 2 d | 7 d | 28 d | Initial | Final |

“Belgium”

| | | | | | | | | | | | | |
|---|---|---|---|---|---|---|---|---|---|---|---|---|
| White | — | 3230 | 21.9 | 10.5 | 3.2 | 0.1 | — | 25.9 | 45.0 | 58.2 | 4:25 | 5:30 |
| Pure glycerine 50% | 400 | 3290 | 24.7 | 12.5 | 4.1 | 0.4 | — | 26.7 | 45.0 | 58.8 | 4:15 | 5:05 |
| Raw glycerine 50% | 400 | 3160 | 26.5 | 14.2 | 5.2 | 0.7 | — | 28.3 | 46.9 | 60.8 | 4:05 | 5:15 |

“Greece”

| | | | | | | | | | | | | |
|---|---|---|---|---|---|---|---|---|---|---|---|---|
| White | — | 3570 | 18.8 | 8.7 | 2.6 | 0.2 | 16.1 | — | 41.6 | 53.0 | 3:20 | 4:05 |
| Pure glycerine 50% | 400 | 3550 | 22.1 | 10.8 | 3.4 | 0.3 | 20.1 | — | 41.6 | 53.8 | 2:30 | 3:00 |
| Raw glycerine 50% | 400 | 3590 | 21.5 | 10.7 | 3.6 | 0.5 | 18.1 | — | 43.8 | 56.6 | 3:10 | 4:00 |

“Italy”

| | | | | | | | | | | | | |
|---|---|---|---|---|---|---|---|---|---|---|---|---|
| White | — | 3560 | 27.5 | 16.4 | 7.8 | 2.4 | — | 22.2 | 38.0 | 52.9 | 3:30 | 4:30 |
| Pure glycerine 50% | 400 | 3480 | 33.6 | 21.1 | 10.5 | 3.2 | — | 26.3 | 39.0 | 49.6 | 3:00 | 3:55 |
| Raw glycerine 50% | 400 | 3590 | 33.0 | 21.3 | 11.1 | 4.0 | — | 24.8 | 40.8 | 51.6 | 3:14 | 3:30 |

Blaine: cement fineness measure;

PSD Laser: cement particle-size distribution, determined by a laser particle-size analyser. This parameter indicates the cement fineness, i.e. how many particles have a longer diameter in percentage terms compared to a given size (in this case: 32, 45, 63 or 90 micron).

As can be seen in table 1, the use of raw glycerine causes a substantial improvement in the compression strength, compared to the reference sample and also causes a considerable increase compared to the use of pure glycerine. It is extremely surprising that such small inorganic salt impurities cause an increase in the compression strength, compared to the pure glycerine. At the moment, this result may not be explained except by putting forward the hypothesis of a synergy between the glycerine and the inorganic salts.

### Advantages

The raw glycerine gives to the cement a compression strength which is higher than the one obtained by using the pure glycerine. It is very surprising that small inorganic salt impurities may give such a technical effect. This may not be currently explained; a synergy between the glycerine and these salts is supposed in any case. Furthermore, the raw glycerine is available in a large amount at a very good price, as a by-product of the production process of biodiesel®; this allows the cement production costs to be considerably reduced.

The re-use of a waste product, such as the raw glycerine, not only allows to cut the disposal costs, but is also an advantage to the environment.

1. Use of raw glycerine as a cement additive in order to improve the compression strength thereof.

2. The use according to claim 1, wherein said raw glycerine comprises 1 to 10% by weight of alkali metal inorganic salts.

3. The use according to claim 1, wherein said raw glycerine comprises 4 to 6% by weight of alkali metal inorganic salts.

4. The use according to claim 2, wherein said salts are selected from: sodium chloride, sodium sulphate, potassium chloride, potassium sulphate or mixtures thereof.

5. The use according to claim 2, wherein said salts are sodium chloride, sodium sulphate or mixtures thereof, preferably sodium chloride.

6. The use according to claim 1, wherein said raw glycerine is obtained as a by-product of the synthesis of alkyl-esters from vegetable oils and alkyl alcohol, in the presence of either an acid or basic catalyst.

7. The use according to claim 6, wherein said vegetable oils are selected from: soybean oil, rape oil, corn oil, preferably rape oil.

8. The use according to claim 6, wherein said alkyl alcohol is methyl alcohol.

9. The use according to claim 6, wherein said basic catalyst is either sodium or potassium hydroxide, preferably sodium hydroxide.

10. The use according to claim 1, wherein said glycerine is added to the clinker either during the conveyance thereof to the mill, or directly in the mill.

11. The use according to claim 10, wherein said glycerine is added to the clinker during the milling step.

12. The use according to claim 1, wherein said glycerine is used as an aqueous solution in a concentration ranging between 10% and 90% by weight, preferably between 10% and 60% by weight.

13. The use according to claim 12, wherein said glycerine aqueous solution is added to the clinker in amounts 20 to 1500 ppm, with reference to the clinker weight, preferably 50 to 1000 ppm.
